(19) United States
(12) Patent Application Publication
(10) Pub. No.: US 2018/0148163 A1
(43) Pub. Date: May 31, 2018

(54) CONTROL SURFACE COMPONENT FOR A HIGH-LIFT DEVICE OF AN AIRCRAFT AND PRODUCTION METHOD THEREFOR

(71) Applicant: Airbus Defence and Space GmbH, Taufkirchen (DE)

(72) Inventors: Michael Bauer, Kircheim b. Munchen (DE); Johann Reichenberger, Ainring (DE)

(21) Appl. No.: 15/826,227

(22) Filed: Nov. 29, 2017

(30) Foreign Application Priority Data
Nov. 30, 2016 (DE) 10 2016 123 096.0

(51) Int. Cl. B64C 21/02; B64C 3/50; B64C 3/22

(52) U.S. Cl. CPC B64C 21/02; B64C 3/50; B64C 2230/20; B64C 2230/14; B64C 2230/22; B64C 3/22

(57) ABSTRACT

A control surface component for reducing a noise level generated by the flow around the control surface component, in particular flap component, for a high-lift device of a wing of an aircraft, having a lift body, which is designed or configured to generate lift and which comprises a lift body end region, a lift body suction side and a lift body pressure side, wherein a foam body, which can be mounted adjoining the lift body end region, is formed separately from the lift body as an integral element and is exposed, is designed or configured to provide, in the mounted state, a plurality of flow paths which fluidically connect the lift body suction side and the lift body pressure side to compensate for a pressure difference prevailing between the lift body suction side and the lift body pressure side.

### CROSS-REFERENCE TO RELATED APPLICATION

This application claims priority to German Patent Application DE 10 2016 123 096.0 filed Nov. 30, 2016, the entire disclosure of which is incorporated by reference herein.

### TECHNICAL FIELD

The disclosure herein relates to a control surface component, in particular flap component, for a high-lift device of an aircraft, having a lift body, which is designed to generate lift and which comprises a lift body end region, a lift body suction side and a lift body pressure side. The disclosure herein furthermore relates to a production method for producing a control surface component of this kind.

### BACKGROUND

The work which has led to this disclosure herein was supported in accordance with Financial Aid Agreement No. 604013 as part of the Seventh European Union Framework Program (RP7/2013).

In the case of modern aircraft of all kinds but principally airplanes, the avoidance of noise pollution is an increasingly important factor. Not only the rise in global air traffic but also increased requirements in respect of noise protection due to building regulations for airports and other environmental legislation are coming increasingly to the fore.

The most well-known source of noise on an airplane are the engines, for which various noise abatement concepts have been presented in numerous publications. WO 2012/110267 A1 is concerned, for example, with “CROR engines” and the noise caused by propeller throb. DE 10 2011 056 826 A1, DE 10 2007 019 762 A1, U.S. Pat. No. 7,124,856 B2 and U.S. Pat. No. 3,481,427 A disclose various noise abatement devices. In some cases, these are based on deflection and, in others, on absorption of the soundwaves. Typical passive sound absorbers and passive noise control linings, referred to as “liners”, are known from DE 10 2013 109 492 A1 and DE 600 05 917 T2, for instance. DE 10 2009 005 163 A1 proposes an active absorber for engines. Common to these concepts is that of reducing noise which has already been produced.

In contrast, devices which prevent the generation of noise itself are also known. A control surface component mentioned at the outset is known from U.S. Pat. No. 9,132,909 B1, for example. Similar control surface components are likewise described in U.S. Pat. No. 8,695,915 B1, U.S. Pat. No. 8,708,272 B1 and U.S. Pat. No. 9,227,719 B2. EP 2 692 632 A1 is likewise concerned with a control surface component of this kind.

The disclosure herein arose in the context of current research, the subject of which is the flow noise caused by control surfaces of the airplane, which can occur especially during the landing approach with the engines throttled and which contributes a large proportion of the noise pollution generated close to the ground in the immediate vicinity of airports. By the disclosure herein, this type of noise generation can be reduced or avoided.

### SUMMARY

It is an object of the disclosure herein to improve aircraft in respect of the noise pollution caused by the aircraft. The object is achieved by the subject matter disclosed herein.

The proposal according to the disclosure herein is to provide a foam body, which can be mounted adjoining the lift body end region, is formed separately from the lift body as an integral element and is exposed and which is designed or configured to provide, in the mounted state, a plurality of flow paths which fluidically connect the lift body suction side and the lift body pressure side to compensate for a pressure difference prevailing between the lift body suction side and the lift body pressure side.

The disclosure herein provides a control surface component for reducing a noise level generated by the flow around the control surface component, in particular flap component, for a high-lift device of a wing of an aircraft, having a lift body, which is designed or configured to generate lift and which comprises a lift body end region, a lift body suction side and a lift body pressure side, and having a porous body, in particular foam body, which can be mounted adjoining the lift body end region, is formed separately from the lift body as an integral element and is exposed, and which is furthermore designed or configured to provide, in the mounted state, a plurality of flow paths which fluidically connect the lift body suction side and the lift body pressure side to compensate for a pressure difference prevailing between the lift body suction side and the lift body pressure side.

It is preferred that the foam body have an exposed pore structure.

It is preferred that the foam body have an open-cell pore structure.

It is preferred that the foam body have an omnidirectional pore structure.

It is preferred that the foam body contain a light metal foam and/or aluminum. It is preferred that the foam body contain a plastics foam, in particular a UV-resistant plastics foam.

It is preferred that the foam body can be mounted flush with the lift body outer surface region situated furthest out in the transverse direction. It is preferred that the foam body can be mounted flush with the lift body suction side and/or the lift body pressure side. Here, the term “flush” should be understood to mean that the foam body can be regarded as aerodynamically smooth. In other words, the foam body or the transition from the foam body to some other (adjacent) part is also “flush” when the laminar flow through the foam body or the transition from the foam body is not significantly affected.

It is preferred that the foam body project outward in the transverse direction beyond the boundary plane.

It is preferred that the lift body end region comprise a free region, which is designed or configured to accommodate the foam body and is delimited by a surface region, in particular a continuous outer surface region, of the lift body.

It is preferred that the free region be delimited in the upward normal direction by the edge of the lift body suction side theoretically extended outward in the transverse direction.

It is preferred that the free region be delimited in the downward normal direction by the edge of the lift body pressure side theoretically extended outward in the transverse direction or that of the profile chord of the lift body.

It is preferred that the free region begin at the thickest point of the lift body in longitudinal cross section, when looking toward the rear in the longitudinal direction.

It is preferred that the free region end at a point of the lift body which is thinner in longitudinal cross section, when looking toward the rear in the longitudinal direction.

It is preferred that the free region be delimited in the transverse direction, in particular inwardly. It is preferred that the free region be delimited in the longitudinal direction.

It is preferred that the free region be delimited on at most three or at most four sides by the surface region, in particular the continuous outer surface region.

It is preferred that the free region be delimited on the front side, the inner side, the rear side and/or the outer side by the surface region, in particular the continuous outer surface region.

It is preferred that the lift body have a lift body outer side, by the edge of which that is theoretically extended rearward in the longitudinal direction the free space is delimited.

It is preferred that the lift body comprise a leading edge region which adjoins the foam body when viewed in the longitudinal direction.

It is preferred that the lift body comprise a leading edge region which has the same width as the foam body in the transverse direction.

It is preferred that the leading edge region have a length of between 20% and 40%, in particular between 25% and 35%, of the profile chord length when viewed in the longitudinal direction.

It is preferred that the lift body comprise a trailing edge region which adjoins the foam body when viewed in the longitudinal direction.

It is preferred that the lift body comprise a trailing edge region which has the same width as the foam body in the transverse direction.

It is preferred that the trailing edge region have a length of between 0% and 20%, in particular between 5% and 15%, of the profile chord length when viewed in the longitudinal direction.

It is preferred that the ratio of the width of the foam body in the transverse direction to the maximum thickness of the lift body in the normal direction be greater than or equal to 0.6 and preferably less than 1.

It is preferred that the foam body have a pore density of between 20 ppi and 40 ppi, in particular 25 ppi to 35 ppi, preferably 30 ppi.

It is preferred that the lift body and the foam body each comprise mounts which are designed for mounting the foam body detachably on the lift body.

It is preferred that the fastener(s) for the foam body comprise a mounting plate, in particular a mounting plate made of light metal and/or aluminum. It is preferred that the foam body have a passage for a fastener.

It is preferred that the fastener(s) for the lift body comprise a recess for a mounting plate. It is preferred that the lift body have an opening for fixing a fastener(s).

It is preferred that the lift body and the foam body each comprise positioner(s) which are designed or configured to interact to position the foam body in the free region. It is preferred that the positioner(s) form a passage for a fastener(s).

The disclosure herein furthermore relates to a high-lift device, in particular flap device, for mounting on a wing of an aircraft, having a preferred control surface component and having a movement device which is designed or configured to move the control surface component from a rest position into an operating position, wherein the control surface component can be mounted on the aircraft, in particular on the wing, by the movement device.

The disclosure herein furthermore provides an aircraft having a wing, in particular a mainplane, which has a preferred high-lift device.

The disclosure herein furthermore provides a production method for producing a control surface component for reducing a noise level generated by the flow around the control surface component, comprising:
providing a lift body, which is designed or configured to generate lift and which comprises a lift body outer end region, a lift body suction side and a lift body pressure side; and
mounting a foam body adjoining the lift body end region, the foam body being formed separately from the lift body as an integral element and being exposed, wherein the foam body is designed or configured to provide, in the mounted state, a plurality of flow paths which fluidically connect the lift body suction side and the lift body pressure side to compensate for a pressure difference prevailing between the lift body suction side and the lift body pressure side.

The production method preferably comprises a step by which a preferred free space described above is produced.

The production method preferably comprises a step by which the foam body is produced by primary forming, in particular casting or laser sintering. The foam body is preferably produced by casting using an expendable mold. In particular, a model foam body is used to form the expendable mold, wherein the model foam body disappears during casting.

Position and direction indications are used below in respect of the direction of flight of an aircraft in normal flight. The “longitudinal direction” is substantially parallel to the direction of flight. Positions and directions parallel to the longitudinal direction are indicated by the terms “front”, “rear” or “longitudinally”. The “transverse direction” is horizontal and substantially at right angles to the longitudinal direction. Positions and directions parallel to the transverse direction are indicated by the terms “inside”, “outside” or “transversely”. Here, “inside” means closer to the longitudinal axis and “outside” means further away from the longitudinal axis. The “normal direction” is substantially at right angles both to the longitudinal direction and to the transverse direction. Positions and directions parallel to the normal direction are indicated by the terms “up”, “down” or “perpendicularly”.

By a preferred control surface component, it is possible to reduce noise emissions. Sources of noise which arise due to turbulence and other aerodynamic effects are reduced by the fact that the foam body mitigates or eliminates an excessively abrupt change in pressure between the suction side and the pressure side of the lift body. Several effects can contribute to noise generation. Air flows around the edges of the control surface component during flight. During this process, vortices can form at various points of the control surface component. The interaction between the vortices and the control surface component itself generates some of the noise emissions. The confluence of different vortices at a trailing edge region of the control surface component is also thought to be a further generation mechanism. Tests by the applicant have shown that, in particular, arrangement of a porous body or foam body in one end region of the control surface component can particularly reduce noise emissions. Arrangement in the end region in which the vortices form is preferred. The aerodynamics of the control surface component are not significantly impaired thereby. In particular, the control surface component is of aerodynamically smooth design and thus does not introduce any additional turbulence into the flow.

### BRIEF DESCRIPTION OF THE DRAWINGS

Illustrative embodiments of the disclosure herein are explained in greater detail below by the schematic and example drawings, in which:

FIG. 1 shows a plan view of an illustrative embodiment of an aircraft;

FIG. 2 shows a partial view of an illustrative embodiment of a control surface component to illustrate the noise generation;

FIG. 3 shows an enlarged partial view of the control surface component from FIG. 2;

FIG. 4 shows a partial view of an illustrative embodiment of a control surface component;

FIG. 5 shows a perspective view of an illustrative embodiment of the control surface component; and

FIG. 6 shows a longitudinal cross-section through the control surface component from FIG. 5.

### DETAILED DESCRIPTION

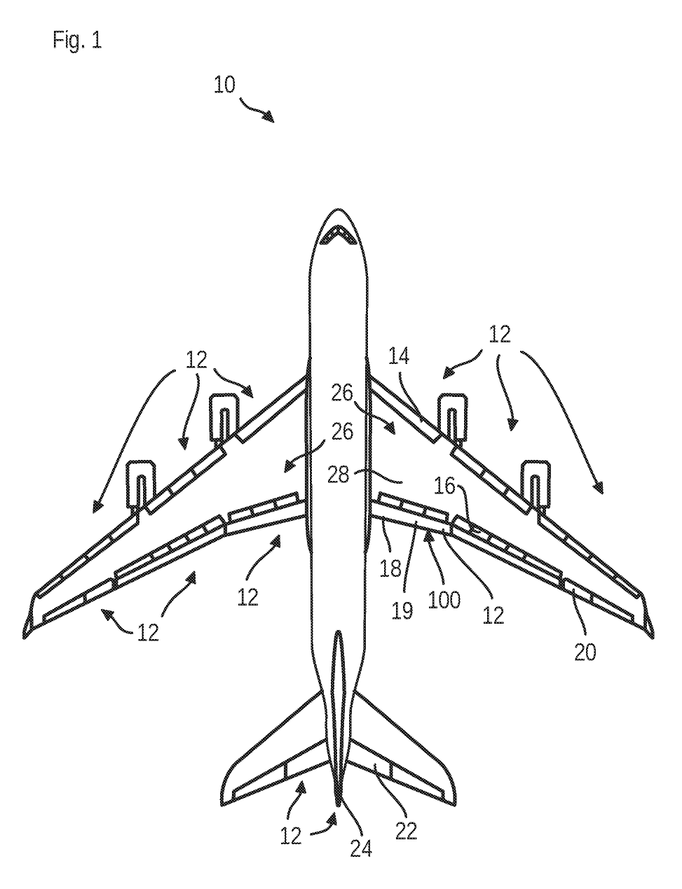

Reference is made first of all to FIG. 1, which shows a plan view of an aircraft 10. The aircraft 10 is an airplane, for example, and comprises a plurality of control surfaces 12, e.g. a slat 14, a spoiler 16, a landing flap 18, an aileron 20, an elevator 22 and a rudder 24. The slat 14, the spoiler 16 and the landing flap 18 are examples of a flap element 19.

The aircraft 10 furthermore comprises a plurality of supporting surfaces 26, which generate the dynamic lift for the aircraft 10. One example of a supporting surface 26 is a mainplane 28. A plurality of the control surfaces 12 can be provided on the mainplane 28. In particular, the mainplane 28 comprises the landing flap 18.

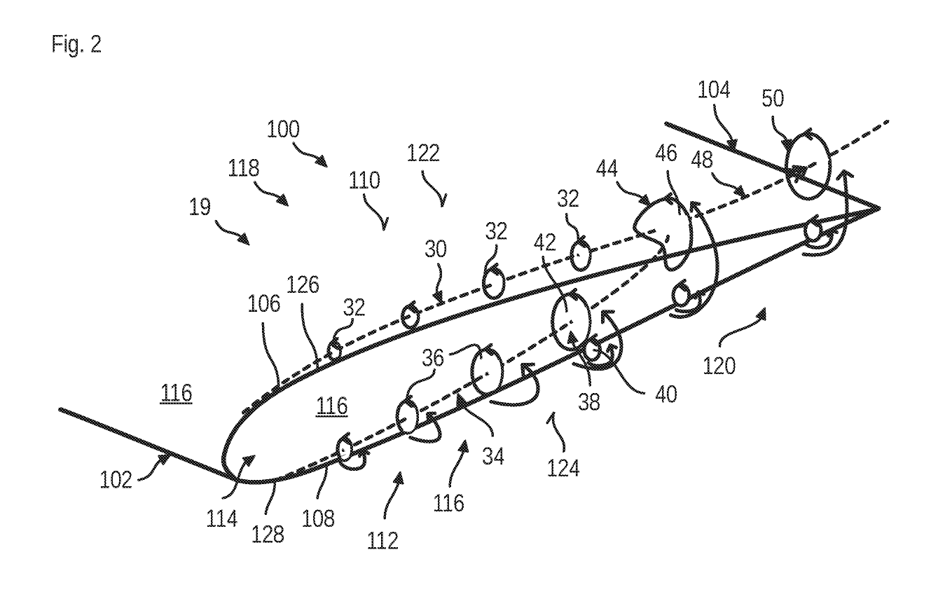

The control surface 12 is formed by a control surface component 100. The control surface component 100 is described in greater detail below with reference to FIG. 2 through FIG. 4. In this example, the control surface component 100 forms the landing flap 18, but can also form another of the control surfaces 12.

The control surface component 100 is of aerodynamically smooth design and has a control surface component leading edge 102, a control surface component trailing edge 104, an upper control surface component transverse edge 106 and a lower control surface component transverse edge 108. The control surface component leading edge 102, the control surface component trailing edge 104 and the upper control surface component transverse edge 106 delimit a control surface component upper surface 110. The control surface component leading edge 102, the control surface component trailing edge 104 and the lower control surface component transverse edge 108 delimit a control surface component lower surface 112. The upper control surface component transverse edge 106 and the lower control surface component transverse edge 108 delimit a control surface component transverse side face 114. The control surface component upper surface 110, the control surface component lower surface 112 and the control surface component transverse side face 114 form at least part of a control surface component surface 116.

The control surface component leading edge 102 and the control surface component trailing edge 104 are spaced apart longitudinally and extend substantially transversely to the fluid flow direction in flight. The control surface component transverse edges 106, 108 extend substantially parallel to the fluid flow direction in flight.

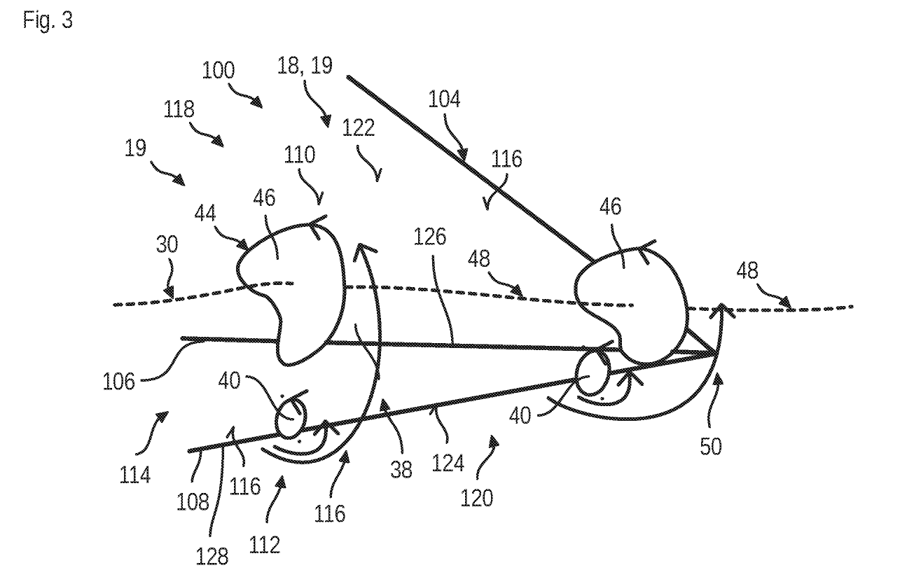

As shown in greater detail in FIG. 2 and FIG. 3, an upper vortex line 30, along which a plurality of upper vortices 32 moves substantially along the control surface component upper surface 110, is formed at the upper control surface component transverse edge 106. A lower vortex line 34, along which lower vortices 36 move, is likewise formed. The lower vortices 36 move substantially along the control surface component transverse side face 114 and in an upward direction toward the upper control surface component transverse edge 106. In a vortex separation region 38, the lower vortices 36 separate into a small lower vortex 40 and a large lower vortex 42. The small lower vortex 40 moves substantially along the control surface component transverse side face 114 in the direction of the control surface component trailing edge 104.

The large lower vortex 42 moves across the upper control surface component transverse edge 106 to a vortex combination region 44, in which the upper vortex line 30 and the lower vortex line 34 meet and the upper vortex 32 combines with the large lower vortex 42 to form a combined vortex 46. The combined vortex 46 moves along a combined vortex line 48 in the direction of the control surface component trailing edge 104 substantially along the control surface component upper surface 110. In a vortex interaction region 50, the small lower vortex 40, the combined vortex 46 and the control surface component trailing edge 104 can interact in such a way that noise is emitted.

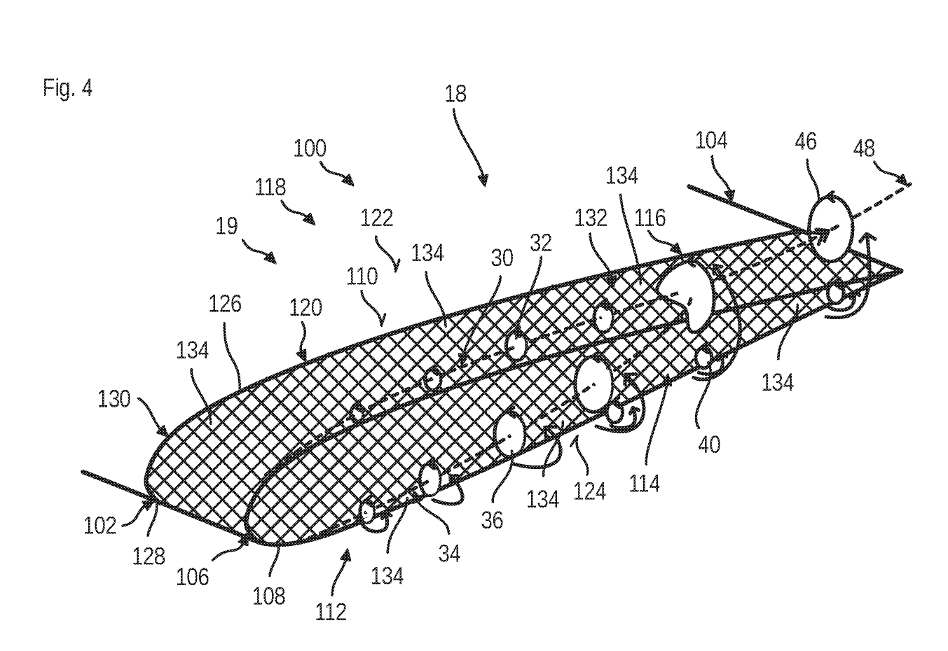

As can be seen from FIG. 4, the control surface component 100 furthermore comprises a lift body 118, which has a lift body end region 120, a lift body suction side 122 and a lift body pressure side 124. The lift body end region 120 is delimited outward in the transverse direction by an upper lift body transverse edge 126 and a lower lift body transverse edge 128. Inward in the transverse direction, the lift body end region 120 does not have a fixed boundary. For the purposes of this description, however, it is assumed that the lift body end region 120 ends inwardly in the transverse direction where there are no longer any significant vortices or no turbulent flow if there are no attachments to the lift body 118. In other words, the lift body end region 120 ends where the fluid flow around the lift body 118 is substantially laminar again or non-turbulent if no further elements are attached to the lift body 118.

The lift body suction side 122 coincides with the control surface component upper surface 110. The lift body pressure side 124 coincides with the control surface component lower surface 112. On the lift body suction side 122, the (dynamic) pressure is lower than on the lift body pressure side 124. The closed lift body 118 leads to a relatively abrupt transition between the lift body suction side pressure and the lift body pressure side pressure.

In order to make the transition less abrupt, the control surface component 100 furthermore comprises a foam body 130. The foam body 130 can be mounted on the lift body end region 120. The foam body 130 is furthermore formed separately from the lift body 118 as an integral element. The foam body 130 is exposed, i.e. it does not have a physically smooth surface but an aerodynamically smooth surface. In other words, the foam body 130 has a pore structure 132 which is in direct contact with the surroundings of the foam body 130. The pore structure 132 is furthermore of open-cell design. The pore structure 132 comprises a plurality of flow paths 134 (also referred to as fluid passages), through which fluid can flow. In the state in which it is mounted on the lift body end region 120, the ambient fluid can flow from the lift body pressure side 124 to the lift body suction side 122 against a resistance via the plurality of flow paths 134. As a result, a pressure difference prevailing between the lift body suction side 122 and the lift body pressure side 124 can be compensated in such a way that the transition between the lift body suction side pressure and the lift body pressure side pressure is less abrupt. To provide a further improvement, the pore structure 132 can furthermore be of omnidirectional design. It is thereby possible to reduce a direction dependence of the pressure compensating function of the foam body. Overall, noise suppression can thus be further increased. It has proven particularly advantageous if the pore structure 132 has between 25 pores per inch (ppi) and 35 ppi.

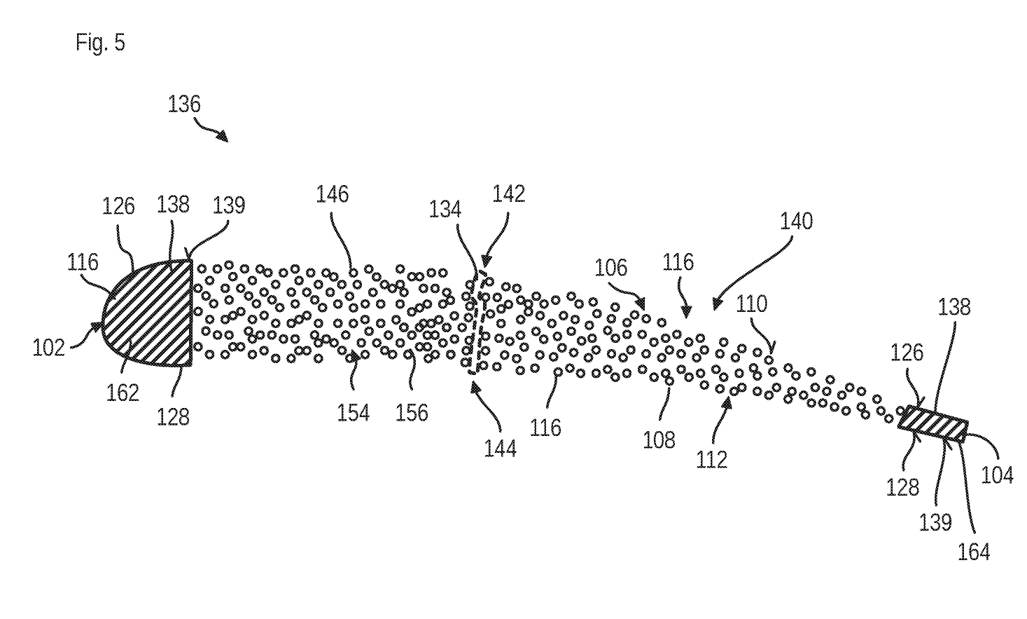

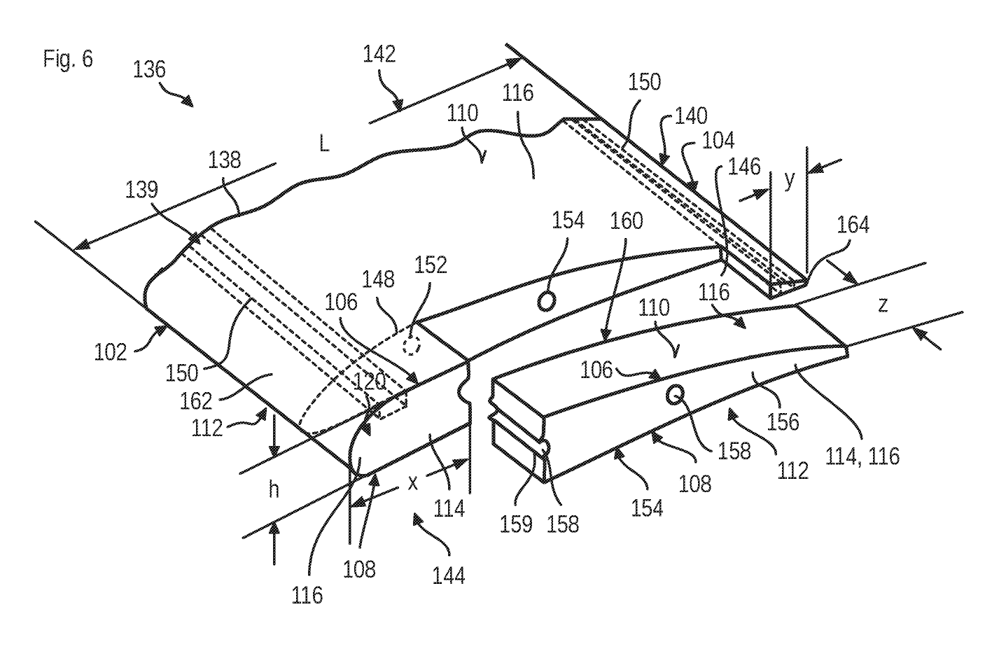

A method for producing or retrofitting a control surface component 136 is described below with reference to FIG. 5 and FIG. 6. Control surface component 136 is described only to the extent that it differs from control surface component 100.

The control surface component 136 comprises a lift body 138 having a lift body end region 140, a lift body suction side 142 and a lift body pressure side 144. The lift body 138 is embodied, for example, as a stringer-rib construction with a self-supporting outer skin 139, which inter alia forms the lift body suction side 142 and the lift body pressure side 144. A free region 146 is produced in the lift body end region 140 by partially removing the lift body suction side 142 and the lift body pressure side 144. In particular, the lift body suction side 142 and the lift body pressure side 144 are moved as far as the first rib 148 of the lift body 138 when viewed from the outside in the transverse direction. The lift body suction side 142 and the lift body pressure side 144 are preferably removed in such a way that the stringers 150 remain unchanged. For example, the first rib 148 is provided with fastener(s) 152. The accesses into the interior of the lift body 138 which are produced during the production of the free region 146 are furthermore closed. In addition, the lift body end region 140 can be provided with positioner(s) 153, which, in particular, can form a passage for further fastener(s).

A foam body 154 can then be fastened to the lift body 138. Foam body 154 is similar in design to foam body 130, especially in respect of its pore structure 156. The foam body 154 is matched to the free region 146 in such a way that the control surface component 136 can be regarded as aerodynamically smooth overall, as before. Furthermore, the foam body 154 has fastener(s) 158 and, in particular, additionally has positioner 159. The fastener(s) 158 can be configured as a mounting plate 160 attached to the foam body 154 or formed integrally therewith, for example. The positioner(s) 159 are preferably provided on the foam body 154 itself and/or the fastener 158. Thus, the foam body 154 can be arranged without much effort in the position assigned to it, it being possible, in particular, for it to be pushed into the free region 146 in the transverse direction from the outside inward, and fastened.

A leading edge region 162 and a trailing edge region 164 of the lift body 138 preferably delimit the free region 146 in the longitudinal direction. The length x of the leading edge region 162 is between 20% and 40% of the total length L of the profile chord of the lift body 138. The length y of the trailing edge region 164 of the lift body 138 is between 0% and 20% of the total length L of the profile chord of the lift body.

Furthermore, the free region 146 is produced in such a way that it begins at the thickest point of the lift body 138, which has the maximum thickness h, and extends in the longitudinal direction to the trailing edge region 164. The selected extent or width L of the foam body 154 is advantageously between 60% and 100% of the maximum thickness h.

Lateral edges of the landing flaps around which air flows—especially on the A320 airplane—cause significant flow noise on the ground, specifically during the landing approach, when the engine is severely throttled and the landing gear has not yet been extended, and thus contribute directly to noise pollution in the environs of airports.

The turbulence and aerodynamic effects, which lead to noise generation at the lateral edge of the flaps, are reduced by the use of a porous material and noise emissions are thus mitigated.

Through the use of the above-described illustrative embodiments—especially the retrofitting of existing A320 fleets belonging to airlines—it is possible to further reduce noise pollution in a particular phase of the landing approach. It is decisive here that this retrofit can be performed without major interventions that compromise the statics of the flap structure.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 aircraft
12 control surface
14 slat
16 spoiler
18 landing flap
19 flap element
20 aileron
22 elevator
24 rudder
26 supporting surface
28 mainplane
30 upper vortex line
32 upper vortex
34 lower vortex line
36 lower vortex
38 vortex separation region
40 small lower vortex
42 large lower vortex
44 vortex combination region
46 combined vortex
48 combined vortex line
50 vortex interaction region
100 control surface component
102 control surface component leading edge
104 control surface component trailing edge
106 upper control surface component transverse edge
108 lower control surface component transverse edge
110 control surface component upper surface
112 control surface component lower surface
114 control surface component transverse side face
116 control surface component surface
118 lift body
120 lift body end region
122 lift body suction side
124 lift body pressure side
126 upper lift body transverse edge
128 lower lift body transverse edge
130 foam body
132 pore structure
134 flow path
136 control surface component
138 lift body
139 outer skin
140 lift body end region
142 lift body suction side
144 lift body pressure side
146 free region
148 first rib
150 stringer
152 fastener
153 positioner(s)
154 foam body
156 pore structure
158 fastener
159 positioner(s)
160 mounting plate
162 leading edge region
164 trailing edge region

1. A control surface component for reducing a noise level generated by flow around the control surface component, in particular flap component, for a high-lift device of a wing of an aircraft, having a lift body, which is configured to generate lift and which comprises a lift body end region, a lift body suction side and a lift body pressure side, which comprises a foam body, which can be mounted adjoining the lift body end region, is formed separately from the lift body as an integral element and is exposed and which is configured to provide, in the mounted state, a plurality of flow paths which fluidically connect the lift body suction side and the lift body pressure side to compensate for a pressure difference prevailing between the lift body suction side and the lift body pressure side.

2. The control surface component as claimed in claim 1, wherein the foam body has an exposed, open-cell and omnidirectional pore structure.

3. The control surface component as claimed in claim 1, wherein the lift body end region has a free region, which is configured to accommodate the foam body and is delimited by a surface region, in particular a continuous outer surface region, of the lift body.

4. The control surface component as claimed in claim 1, wherein the free region is delimited in an upward normal direction by an edge of the lift body suction side theoretically extended outward in a transverse direction, and/or wherein the free region is delimited in a downward normal direction by the edge of the lift body pressure side theoretically extended outward in a transverse direction or that of the profile chord of the lift body.

5. The control surface component as claimed in claim 1, wherein the free region begins at a thickest point of the lift body in longitudinal cross section, when looking toward a rear in a longitudinal direction.

6. The control surface component as claimed in claim 1, wherein the lift body has a lift body outer side, by the edge of which that is theoretically extended rearward in a longitudinal direction the free space is delimited.

7. The control surface component as claimed in claim 1, wherein the lift body comprises a leading edge region which adjoins the foam body when viewed in a longitudinal direction and has a same width as the foam body in the transverse direction, wherein the leading edge region has a length of between 20% and 40%, in particular between 25% and 35%, of a profile chord length when viewed in the longitudinal direction.

8. The control surface component as claimed in claim 1, wherein the lift body comprises a trailing edge region which adjoins the foam body when viewed in the longitudinal direction and has the same width as the foam body in the transverse direction, wherein the trailing edge region has a length of between 0% and 20%, in particular between 5% and 15%, of a profile chord length when viewed in the longitudinal direction.

9. The control surface component as claimed in claim 1, wherein a ratio of width of the foam body in the transverse direction to the maximum thickness of the lift body in a normal direction is greater than or equal to 0.6 and is preferably less than 1.

10. The control surface component as claimed in claim 1, wherein the foam body has a pore density of between 20 ppi and 40 ppi, in particular 25 ppi to 35 ppi, preferably 30 ppi.

11. The control surface component as claimed in claim 1, wherein the lift body and the foam body each comprise mounts which are designed for mounting the foam body detachably on the lift body.

12. The control surface component as claimed in claim 1, wherein the lift body and the foam body each comprise a positioner configured to interact to position the foam body in the free region.

13. A high-lift device, in particular flap device, for mounting on a wing of an aircraft, having a control surface component as claimed in claim 1, and having a movement device configured to move the control surface component from a rest position into an operating position, wherein the control surface component can be mounted on the aircraft, in particular on the wing, by the movement device.

14. An aircraft having a wing, in particular a mainplane, which has a high-lift device as claimed in claim 1.

15. A production method for producing a control surface component for reducing a noise level generated by flow around the control surface component, comprising:
providing a lift body, which is configured to generate lift and which comprises a lift body outer end region, a lift body suction side and a lift body pressure side; and
mounting a foam body adjoining the lift body end region, the foam body being formed separately from the lift body as an integral element and being exposed, wherein the foam body is configured to provide, in the mounted state, a plurality of flow paths which fluidically connect the lift body suction side and the lift body pressure side to compensate for a pressure difference prevailing between the lift body suction side and the lift body pressure side.
